(19) United States
(12) Patent Application Publication
(10) Pub. No.: US 2023/0415705 A1
(43) Pub. Date: Dec. 28, 2023

(54) COMMERCIAL VEHICLE LIGHT WASHING SYSTEM

(71) Applicant: SEABORN DEVELOPMENT LLC, Longmont, CO (US)

(72) Inventor: John SEABORN, Longmont, CO (US)

(73) Assignee: SEABORN DEVELOPMENT, LLC, Longmont, CO (US)

(21) Appl. No.: 17/849,801

(22) Filed: Jun. 27, 2022

(51) Int. Cl. B60S 1/60; B60S 1/48

(52) U.S. Cl. CPC B60S 1/60; B60S 1/481

(57) ABSTRACT

A wireless vehicle light washing system that is activated by a remote controller to enable washer fluid spray nozzles to spray/wash external lights of a semitrailer or other commercial vehicle from within a cab of the semitruck or other commercial vehicle. The wireless vehicle light washing system can be wirelessly activated to independently control the washer fluid spray nozzles fixed to the semitrailer or other commercial vehicle as desired.

### STATEMENT REGARDING FEDERALLY SPONSORED RESEARCH OR DEVELOPMENT

Not applicable.

### COPYRIGHT NOTICE

A portion of this disclosure contains material which may be subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND OF THE INVENTIVE CONCEPT

### 1. Field of the Invention

The present inventive concept relates to a wireless system to wash lights (i.e., outer lenses of lights) of commercial vehicles. More particularly, the present inventive concept relates to a wireless system to wash rear lights of large commercial vehicles, including semi-trailers and semitrucks.

### 2. Description of the Related Art

It has been surveyed that truck drivers drive an estimated 10 billion miles every year, and a single semitruck drives about 45,000 miles a year on average. According to the Federal Highway Administration, long-distance trucks travel upwards of 100,000 miles a year. Around 42% of all miles driven by commercial vehicles are driven by semitrucks. It doesn't take long at all for snow and slush to accumulate in the back of a semitruck's trailer during a blizzard or heavy snowstorm. Very often truck drivers for all types of trucks are seen pulled over along the side of a busy highway in attempts to clean snow and ice off the back lights of their trucks and trailers, where the buildup of snow, slush, etc., becomes so bad that the lights on the trucks and trailers cannot even be located. Worse, during such bad weather conditions the shoulders of roads are covered with so much snow, ice and slush that truck drivers cannot even find a place to pull over to clean the lights. Before you know it, all vehicles along a stretch of the highway are at a standstill due to one or more semitrucks jackknifed along a center and/or a side of the highway.

Lights of rear lights on large commercial vehicles, such as back up, turn signal and brake lights are well known to collect dirt, slush, snow and ice that is sprayed up from a road surface in which these vehicles are traveling. As a result, the coated (with dirt, slush, snow and ice) lights cannot be seen by drivers following behind these large vehicles, which leads to safety hazards. Dirt, slush, snow and ice obstruction on these rear lights is especially dangerous in winter conditions. Even the heat that radiates from the lights is not strong enough to melt off buildup of snow and ice that accumulates on the lights, not to mention that the heat can do nothing to alleviate dirt and slush from being coated on the lenses of the lights.

Moreover, most large vehicle brake and backup lights have been transitioning from incandescent lights to LED lights. LED lighting does not produce heat, and thus cannot be relied on to radiate any amount of heat to melt off snow and ice from the rear lights that encase the LED lighting.

Currently, in order to clean lights of rear lights on large commercial vehicles, a driver of the vehicle must pull the vehicle over to the side of the road, or wait until a rest area is available, in order to exit the road, exit the vehicle, regardless of severity of the environmental weather, and manually scrape, wash and/or brush off the ice, dirt, slush and snow from the lights. This practice is well known to expose the driver of such large commercial vehicles to a high-risk environment, especially in icy, slippery, blinding storm and winter conditions.

FIG. 1A illustrates a rear frame 100 of a common commercial truck. As illustrated, rear lights 104 are required by law on all commercial trucks and trailers, as well as on all other vehicles, in order to help drivers behind these commercial trucks and trailers to see them during less than clear environmental conditions, such as, for example night-time, overcast weather, heavy rain, snow, sleet, etc. A frame 102 is generally provided around the lights 104 to protect the lights 104 from environmental conditions as well as from being damaged by objects that may come into contact with the rear end of the truck or trailer on the roads and highways. A bumper 106 is also commonly used to pad any contact a vehicle behind the commercial truck or trailer may make with the truck or trailer in order to provide additional protection from damage to the lights 104.

FIG. 1B illustrates a line drawing of a rear frame 100 of a commercial truck such as the one illustrated in FIG. 1A.

### SUMMARY OF THE INVENTIVE CONCEPT

The present general inventive concept provides a wireless system to wash lights (i.e., outer lenses of lights) of commercial vehicles, and more particularly, the present inventive concept relates to a wireless system to wash rear lights of large commercial vehicles, including semi-trailers and semitrucks.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a commercial vehicle light washing system, comprising: a fluid tank to contain washing fluid; at least one fluid spray nozzle to spray washing fluid onto a corresponding light of a commercial vehicle, the least one fluid spray nozzle being configured to be attachable to a position on a commercial vehicle directly adjacent to and facing the corresponding commercial vehicle light; a fluid pump including a computer system configured to control the fluid pump to pump washing fluid from the fluid tank and selectively feed the washing fluid to each of the at least one fluid spray nozzle; and a remote controller configured to wirelessly connect to the computer system of the fluid pump to control the pumping and feeding operations of the fluid pump.

In an exemplary embodiment, the computer system and remote controller can wirelessly connect through Bluetooth.

In another exemplary embodiment, the computer system and remote controller can wirelessly connect through radio frequency (RF) signals.

In another exemplary embodiment, the system can further comprise: a first hose to carry washing fluid from the fluid tank to the pump; and at least one second hose to carry washing fluid from the pump to a corresponding one of the at least one fluid spray nozzle.

In still another exemplary embodiment, the at least one fluid spray nozzle can include a bracket that connects to a frame of commercial vehicle adjacent to a corresponding light.

In still another exemplary embodiment, the remote controller can include a user interface.

The foregoing and/or other features and utilities of the present general inventive concept may also be achieved by providing a commercial vehicle light washing system, comprising: a fluid tank to contain washing fluid; at least one fluid spray nozzle to spray washing fluid onto a corresponding light of a commercial vehicle, the least one fluid spray nozzle including a wireless operated switch to control opening and closing thereof and being configured to be attachable to a position on a commercial vehicle directly adjacent to and facing the corresponding commercial vehicle light; a fluid pump including a wirelessly controlled computer system configured to pump washing fluid from the fluid tank to each of the at least one fluid spray nozzle; and a remote controller configured to wirelessly connect to the compute system of the fluid pump to control the pumping of the fluid pump and to wirelessly connect to the switch of the at least one fluid spray nozzle to control spraying of washing fluid therethrough.

In an exemplary embodiment, the remote controller wirelessly connects to computer system and the switch of the at least one fluid spray nozzle through Bluetooth.

In another exemplary embodiment, the remote controller can wirelessly connect to the computer system and the switch of the at least one fluid spray nozzle through radio frequency (RF) signals.

In another exemplary embodiment, the at least one fluid spray nozzle can include a bracket that connects to a frame of commercial vehicle adjacent to a corresponding light.

In still another exemplary embodiment, the remote controller can include a user interface to independently control the control system of the fluid pump and each switch of the at least one fluid spray nozzle.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1A illustrates a conventional rear light arrangement for a commercial truck or semitrailer of a semitruck.

FIG. 1B illustrates a front view of the conventional rear light arrangement for a commercial truck or semitrailer of a semitruck of FIG. 1

FIG. 2A illustrates a plan view of a wireless commercial vehicle lens washing system according to an exemplary embodiment of the present inventive concept.

FIG. 2B illustrates a side view of spray nozzles of the wireless commercial vehicle lens washing system, according to an exemplary embodiment of the present inventive concept.

FIG. 2C illustrates a side view of spray nozzles of the wireless commercial vehicle lens washing system, according to another exemplary embodiment of the present inventive concept.

FIG. 3 illustrates a schematic view of computer system of the wireless commercial vehicle lens washing system, according to an exemplary embodiment of the present inventive concept.

FIG. 4A illustrates a user interface of a software application of the wireless commercial vehicle lens washing system, according to an exemplary embodiment of the present inventive concept.

FIG. 4B illustrated a user sub-interface of the software application of FIG. 4A.

FIG. 5 illustrates an exemplary placement of and programming control options of spray nozzles of a wireless commercial vehicle lens washing system according to exemplary embodiment of the present inventive concept.

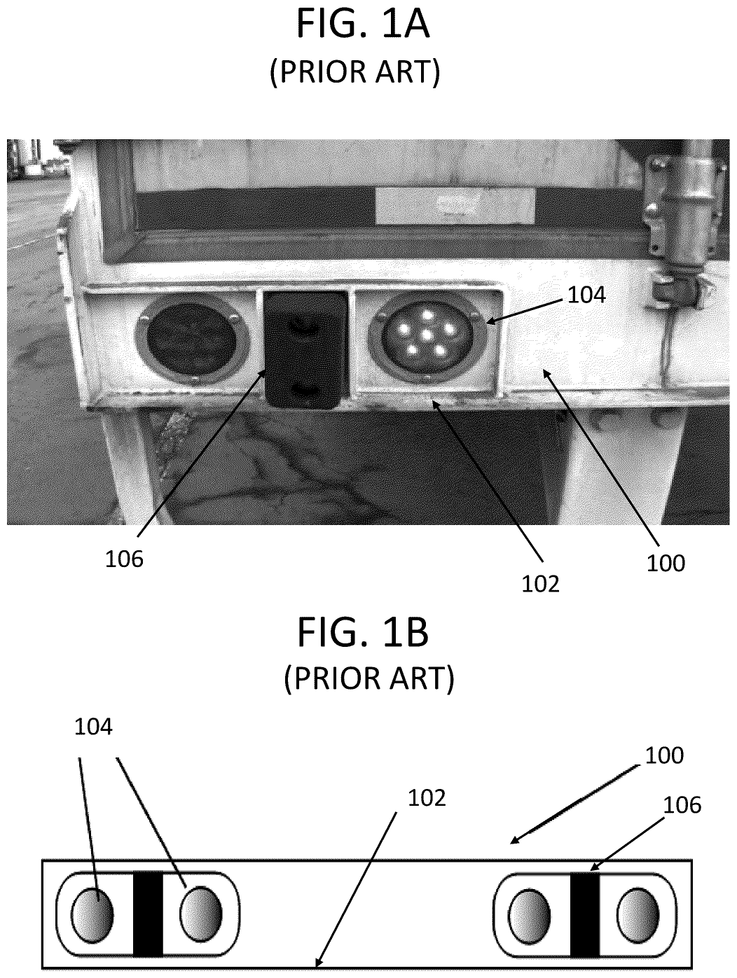

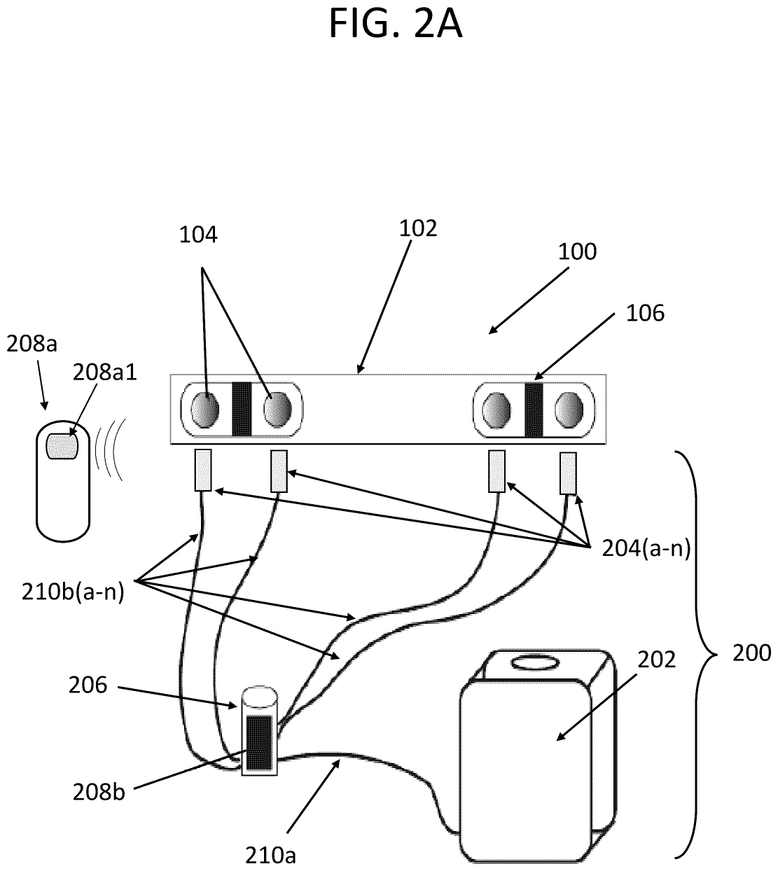

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures. Also, while describing the present general inventive concept, detailed descriptions about related well-known functions or configurations that may diminish the clarity of the points of the present general inventive concept are omitted.

It will be understood that although the terms “first” and “second” are used herein to describe various elements, these elements should not be limited by these terms. These terms are only used to distinguish one element from another element. Thus, a first element could be termed a second element, and similarly, a second element may be termed a first element without departing from the teachings of this disclosure.

Expressions such as “at least one of,” when preceding a list of elements, modify the entire list of elements and do not modify the individual elements of the list.

All terms including descriptive or technical terms which are used herein should be construed as having meanings that are obvious to one of ordinary skill in the art. However, the terms may have different meanings according to an intention of one of ordinary skill in the art, case precedents, or the appearance of new technologies. Also, some terms may be arbitrarily selected by the applicant, and in this case, the meaning of the selected terms will be described in detail in the detailed description provided herein. Thus, the terms used herein must be defined based on the meaning of the terms together with the descriptions provided throughout the specification.

Also, when a part “includes” or “comprises” an element, unless there is a particular description contrary thereto, the part can further include other elements, not excluding the other elements. In the following description, terms such as “unit” and “module” indicate a unit to process at least one function or operation, wherein the unit and the block may be embodied as hardware or software or embodied by combining hardware and software.

Hereinafter, one or more exemplary embodiments of the present general inventive concept will be described in detail with reference to accompanying drawings.

Exemplary embodiments of the present general inventive concept are directed to a wireless apparatus and system to wash rear lights of large commercial vehicles, trailers and trucks.

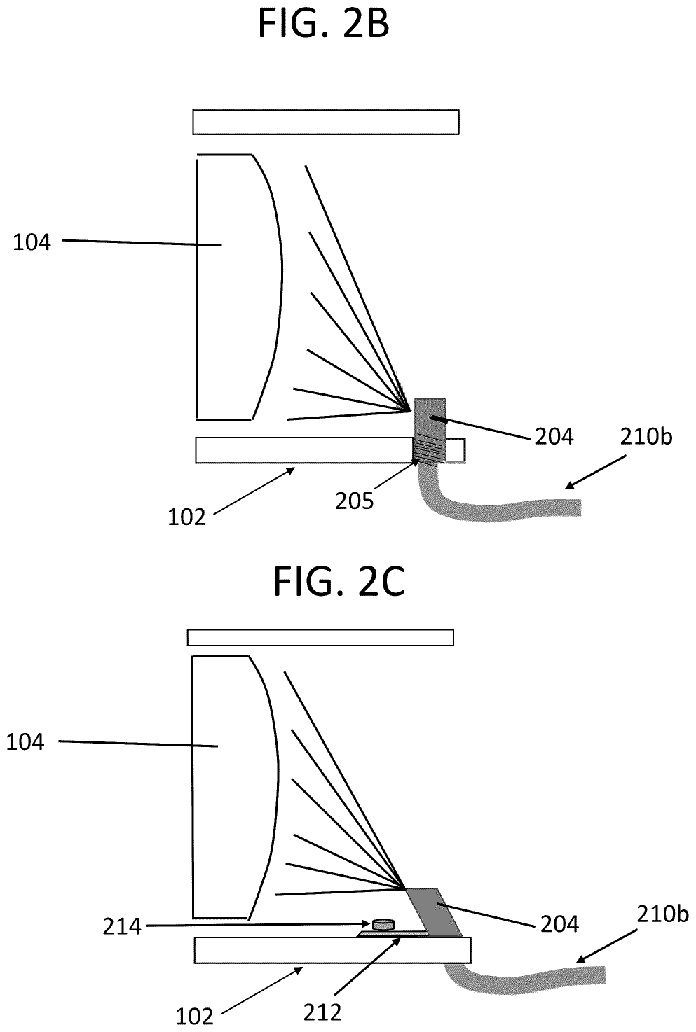

FIG. 2A illustrates a wireless vehicle lens washing system 200 to wash the lenses of rear lights 104 of large commercial vehicles, including semitrailers and semitrucks, according to an exemplary embodiment of the present inventive concept. The wireless vehicle lens washing system 200 can include an all-weather fluid reservoir 202 that can be connected underneath the commercial vehicle, trailer or truck. Also provided as part of the wireless vehicle lens washing system 200 is a set of spray nozzles 204(a-n). Preferably one spray nozzle 204 is provided to spray/wash a corresponding rear light 104 disposed at the back of a commercial vehicle, trailer or truck. Each spray nozzle 204(a-n) can be manufactured to conform with the size, position and/or other characteristics of the respective rear light 104 in which the corresponding spray nozzle 204 is designed to spray. For example, while a spray nozzle 204a may be designed to have a relatively small body with a short spray radius for a correspondingly small sized light 104, another spray nozzle 204b may be designed to have a correspondingly larger body with a wide spray radius to spray a cleaning fluid across an entire surface of a correspondingly large-sized rear light 104.

Each of the spray nozzles 204(a-n) is preferably permanently fastened to a location on the commercial vehicle, trailer or truck directly adjacent to a respective rear light 104. Since most commercial vehicles include a frame 102 surrounding the rear lights 104, the spray nozzles 204(a-n) are preferably fixed to the frames 102 directly below the corresponding rear light 104. However, the position of the spray nozzles 204(a-n) can vary depending on the frame of the vehicle or depending on other factors which require positioning of the spray nozzles 204 with respect to the rear lights 104, so that the most efficient cleaning of lenses of the rear lights 104 can be performed.

According to an example embodiment of the present inventive concept, the spray nozzles 204(a-n) may be embedded into the frame 102 on the back of the commercial vehicle, semitrailer or semitruck. FIG. 2B illustrates an example embodiment where the spray nozzle(s) 204 is formed through a hole in the rear frame 102 of a commercial vehicle or trailer of a semitruck. Once a spray nozzle 204 is placed within the hole, the spray nozzle 204 can be welded, bolted, rivetted, or threaded thereto. In an example embodiment, the holes formed in the frame 102 can include threads formed therein using a tap tooling device, while an outer circumference of the rear lights 104 can have threads formed thereon using a die tooling device. FIG. 2B illustrates an example embodiment wherein a body portion of the spray nozzle 204 includes threads 205 formed thereon, thus allowing the spray nozzle 204 to be threaded into a hole formed in the commercial vehicle frame 102.

FIG. 2C illustrates an alternative embodiment for securing spray nozzles 204, where the spray nozzles 204(a-n) may be attached to a bracket 212, which in turn is fixed to the frame 102. The bracket 212 can be fixed to the frame 102 via bolts, via welding onto the frame 102, via rivets, or can be fixed to the frame 102 by any other equivalent means that will ensure the spray nozzles 204(a-n) will remain securely in place to effectively spray a cleaning fluid onto the respective vehicle lights 104 to remove dirt, mud, slush, snow and ice therefrom.

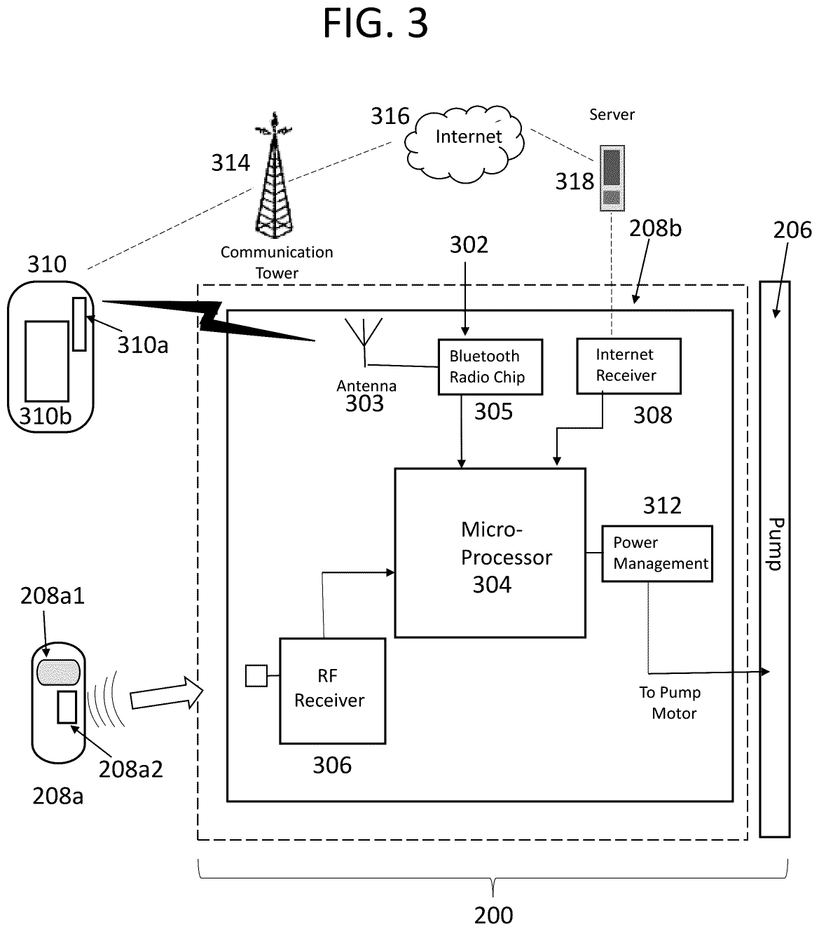

The wireless vehicle lens washing system 200 may also include a fluid pump 206 (see FIG. 2A) which is configured to pump an all-weather washing fluid from the reservoir 202 through a hose 210a or other fluid transportation unit, and then to each of the spray nozzles 204(a-n) through respective hoses 210b(a-n) or other similar fluid transportation units. The fluid pump 206 can include a small computer system 208b that can process wireless signals received through an RF receiver, through a Bluetooth™ receiver, and/or through the Internet. As illustrated in FIG. 2A, a wireless remote control 208a can be used to activate the fluid pump 206 by sending a signal to the computer system 208b when a button 208al is pushed by a user seated in the corresponding commercial vehicle, or cab of a semitruck. However, other means for controlling the fluid pump 206 can be provided, as described in more detail below. The computer system 208b of the fluid pump 206 is also described in more detail with reference to FIG. 3.

Referring to FIG. 3, the computer system 208b of the fluid pump 206 can be configured to include one or more of a radio frequency (RF) receiver 306 to receive RF signals, a combination Bluetooth™ radio chip 302 and antenna 303 to receive Bluetooth™ signals, and/or an Internet receiver 308 to receive signals from a server 318 via the Internet 316. The computer system 208b includes at least one micro-processor 304 that is configured to receive a signal from either the Bluetooth Radio Chip 305, the RF receiver 306 and/or the Internet receiver 308, and to process the received signal into a control signal for controlling the liquid pump 206 motor (not illustrated). The control signal processed by the micro-processor 304 can then be fed to a power management unit 312, which can manage the power provided to the fluid pump 206 based on the processed signal received from the micro-processor 304.

As pointed out above, a remote control 208a can be provided with the wireless vehicle lens washing system 200. The remote control 208a, according to an exemplary embodiment, can be configured with a button 208al, which when pressed, will transmit an RF signal via an RF transmitter 208a2 provided in the remote 208a. The signal transmitted by the RF transmitter 208a2 is received by the RF received 306 of the wireless vehicle lens washing system 200, which will provide the received signal to the micro-processor 304 for processing. Alternatively, the remote 208a can be configured to transmit a WiFi signal to the wireless vehicle lens washing system 200.

In an alternative example embodiment of the present inventive concept, a software application is developed to control the wireless vehicle lens washing system 200. A user of a mobile device 310 can download the software application. Once the software application is downloaded, the software application can display a user interface on the mobile device 310 prompting the user to enter the user's Identification (ID), Password (PSWD) and a specific code (SC), where the SC corresponds with a specific wireless vehicle lens washing system 200 that is connected to the commercial vehicle in which the user will drive. The ID, PSWD and SC can be provided by a business that owns/operates the commercial vehicles, and either leases or owns an Application Programming Interface (API) which controls the software application, wireless vehicle lens washing system 200 and associated server 318.

As illustrated in FIG. 3, a user can download the wireless vehicle lens washing system 200 software application onto his/her mobile device 310. Once the software application is downloaded, the software application can be processed via a processor of the mobile device 310 to operate a transceiver 310a of the mobile device 310 to transmit a wireless signal to the server 318. The server 318 is provided to manage communications between the downloaded software application and the wireless vehicle lens washing system 200. The signal transmitted by the mobile device transceiver 310a can be sent through a communication tower 314 and the Internet 316 to communicate a specific operation to the server 318. The specific operation(s) communicated to the server 318 depends on the button(s) selected on a software application user interface 310b provided by the downloaded software application. The server 318 can communication with an Internet receiver 308 of the wireless vehicle lens washing system 200 to forward the signal from the mobile device transceiver 310a to the Internet receiver 308. The wireless vehicle lens washing system 200 will use the received signal to control the liquid pump 206 according to control features selected at the software application interface 310b.

The downloaded software application associated with the wireless vehicle lens washing system 200 can include the user interface 310b that can be displayed on the mobile device 310 upon a successful download of the software application at the mobile device 310. The user interface 310b indicates various operations that can be performed at the wireless vehicle lens washing system 200 via the downloaded application software program. The specific operations available to be performed by the software application can be performed by selecting these operations via the user interface 310b.

According to another alternative example embodiment, a user of a mobile device 310 can connect with a Bluetooth™ chip embedded in the wireless vehicle lens washing system 200 by enabling the mobile device Bluetooth™ settings and selecting the Bluetooth™ signal transmitted by the combination Bluetooth™ Radio Chip 305 and antenna 303 of the wireless vehicle lens washing system 200. Once the mobile device 310 and the Bluetooth™ Radio Chip 305 are connected, the mobile device 310 can transmit signals to the vehicle lens washing system 200 to control the pump 206 via the computer system 208b, thus providing controlled transmission of washing fluid to the spray nozzles 204(a-n).

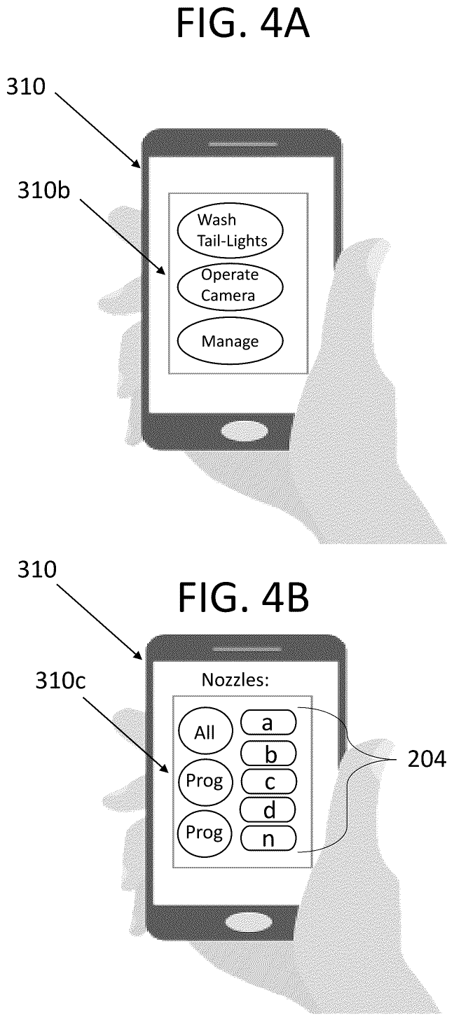

Referring to FIG. 4A, the mobile device 310 is illustrated as displaying the software application user interface 310b of the wireless vehicle lens washing system 200. The software application user interface 310b can provide a variation of functions to be performed, including controlling the pump 206 to provide washing fluid to the spray nozzles 204(a-n) fixed to the back end of a commercial vehicle, controlling a camera (not illustrated) fixed to a desired location on the back end of the commercial vehicle or semitruck trailer, and controlling other features as desired. Further, when a user selects the feature of “Wash Tail Lights,” (aka: operating the pump 206, a sub-interface 310c takes the place of the user interface 310b. As illustrated in FIG. 4C, the sub-interface 310c allows a user to choose all of the spray nozzles 204(a-n) to be operated, to choose a specific spray nozzle 204(a-n) to be operated, or to choose a pre-programmed group of spray nozzles 204(a-n) to be operated.

In another example embodiment, the sub-interface 310c can be configured to control each of the individual spray nozzles 204 that are fixed to a rear frame 102 of a commercial vehicle or trailer, wherein each of the spray nozzles 204 can include a wireless switch to open and close the nozzles 204. Alternatively, a set of spray nozzles 204 that are fixed to another location of a commercial vehicle or trailer can be programmed to operate by selecting another one of the programmable buttons. In other words, in this example embodiment there are a set of programmable buttons on the sub-interface 310c that can be programmed to control switches corresponding to a certain number of spray nozzles 204, or spray nozzles 204 located at a specific place on a commercial vehicle, or any other combination of spray nozzles 204 that the user desires to program on the sub-interface 310c to operate the spray nozzles 204(a-n).

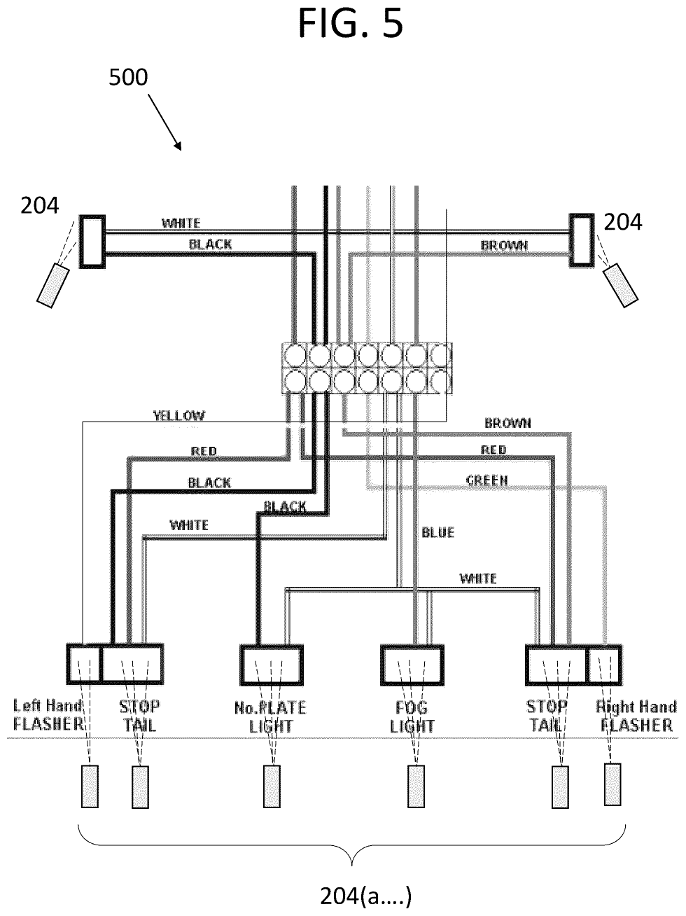

FIG. 5 illustrates a typical semitrailer wiring schematic 500. As illustrated, lights can be placed at the back, sides and a front portion of a semitrailer. Also illustrated are spray nozzles 204(a-n) placed at different locations on semitrailer to correspond with the position of each of the lights. Accordingly, by programming the software application to control different arrangements of spray nozzles 204(a-n), the user can select any number or arrangement of the spray nozzles 204(a-n) to operate through the pump 20 or at switches of the spray nozzles 204(a-n), so that the lights 104 on the semitrailer that require cleaning can be cleaned by the press of a button on the user's mobile device 310 while the user remains safe inside the cab of a semitruck or other commercial vehicle.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A commercial vehicle light washing system, comprising:
a fluid tank to contain washing fluid;
at least one fluid spray nozzle to spray washing fluid onto a corresponding light of a commercial vehicle, the least one fluid spray nozzle being configured to be attachable to a position on a commercial vehicle directly adjacent to and facing the corresponding commercial vehicle light;
a fluid pump including a computer system configured to control the fluid pump to pump washing fluid from the fluid tank and selectively feed the washing fluid to each of the at least one fluid spray nozzle; and
a remote controller configured to wirelessly connect to the computer system of the fluid pump to control the pumping and feeding operations of the fluid pump.

2. The system according to claim 1, wherein the computer system and remote controller wirelessly connect through Bluetooth.

3. The system according to claim 1, wherein the computer system and remote controller wirelessly connect through radio frequency (RF) signals.

4. The system according to claim 1, further comprising:
a first hose to carry washing fluid from the fluid tank to the pump; and
at least one second hose to carry washing fluid from the pump to a corresponding one of the at least one fluid spray nozzle.

5. The system according to claim 1, wherein the at least one fluid spray nozzle includes a bracket that connects to a frame of commercial vehicle adjacent to a corresponding light.

6. The system according to claim 1, wherein the remote controller includes a user interface.

7. A commercial vehicle light washing system, comprising:
a fluid tank to contain washing fluid;
at least one fluid spray nozzle to spray washing fluid onto a corresponding light of a commercial vehicle, the least one fluid spray nozzle including a wireless operated switch to control opening and closing thereof and being configured to be attachable to a position on a commercial vehicle directly adjacent to and facing the corresponding commercial vehicle light;
a fluid pump including a wirelessly controlled computer system configured to pump washing fluid from the fluid tank to each of the at least one fluid spray nozzle; and
a remote controller configured to wirelessly connect to the compute system of the fluid pump to control the pumping of the fluid pump and to wirelessly connect to the switch of the at least one fluid spray nozzle to control spraying of washing fluid therethrough.

8. The system according to claim 5, wherein the remote controller wirelessly connects to computer system and the switch of the at least one fluid spray nozzle through Bluetooth.

9. The system according to claim 5, wherein the remote controller wirelessly connects to computer system and the switch of the at least one fluid spray nozzle through radio frequency (RF) signals.

10. The system according to claim 5, wherein the at least one fluid spray nozzle includes a bracket that connects to a frame of commercial vehicle adjacent to a corresponding light.

11. The system according to claim 7, wherein the remote controller includes a user interface to independently control the control system of the fluid pump and each switch of the at least one fluid spray nozzle.
